(19) United States
(12) Patent Application Publication
(10) Pub. No.: US 2010/0008182 A1
(43) Pub. Date: Jan. 14, 2010

(54) MAGNETIC MIXING SYSTEM

(76) Inventors: Michael Krusche, Chemnitz (DE); Dominik Mueller, Crimmitschau (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/523,312

(22) PCT Filed: Jan. 8, 2008
(86) PCT No.: PCT/DE2008/000024

§ 371 Date: Jul. 30, 2009

(30) Foreign Application Priority Data
Jan. 15, 2007 (DE) 20 2007 000 665.9

(51) Int. Cl. B01F 13/08; B01F 15/00

(52) U.S. Cl. 366/142; 366/273

(57) ABSTRACT

The invention relates to a magnetic mixing system comprising a mixing body, which is located in a container filled with a medium and which can be made to rotate by a rotating magnetic field that is generated by a solenoid system, and comprising an electronic controller and regulator. According to the invention, the inactivity of the mixing body can be detected and/or conclusions concerning the viscosity of the medium can be drawn and/or the height of the magnetic field can be modified in order to transfer the mixing body to a floating state and/or the electronic controller and regulator is at a location that is remote from the solenoid system. The magnetic mixing system permits the mixing of a medium in the form of a liquid, a liquid-solid mixture, a liquid-gas mixture, a gas-solid mixture or a liquid-gas-solid mixture by means of the mixing body.

The present invention relates to a magnetic stirrer system with a stirrer bar located in a liquid filled vessel wherein the stirrer bar can be moved in a rotary motion by a rotating magnetic field. In plants that realize multiple chemical processes at the same time without changing the reaction conditions, such as micro reactors for testing and developing new catalysts, stirring of the material to be tested is necessary. To conserve space, using a magnet stirrer is beneficial. In order to keep the process of stirring reproducible, a detection device is required to monitor the actual rotation of the radial flow impeller. This is not possible using a conventional magnetic stirrer.

Known from Patent DE 42 01693 C1 is a magnetic stirrer with a stirrer bar located in a liquid filled vessel wherein the stirrer bar can be moved in a rotary motion by a rotating magnetic field, and a sensor monitoring the synchrony of the stirrer bar and the driving magnetic field. The magnetic field for the rotary motion is generated by a number of fixed coils which are high-impedance powered by phase-shifted alternating currents (alternating-current driving type display). At the same time, at least one of the coils serves as a sensor coil for monitoring the synchrony of the stirrer bar and the driving magnetic field, enabling synchrony monitoring without fitting a separate sensor.

However, due to the inaccuracy of the system, it is not possible to monitor the rotation of the stirring bar reliably. Another disadvantage known from Patent DE 42 01693 C1 is the high heat entry.

The present invention is directed at developing a magnet stirrer system which provides a reliable detection of the stirrer bar rotation, as well as allowing to stir materials of high viscosity, and conclusions on the respective viscosity. Furthermore, the present invention reduces heat entry effects. In accordance with the properties of the first right of protection, this task is being solved. The present invention addresses these items using additional inventive steps.

The magnetic stirring system has a stirring body located in a vessel filled with a material. This stirring body can be motioned in a rotary manner via a magnetic field generated by a system of coils, and has an electronic control wherein

stopping/stalling the stirring body is detectable
and/or
   conclusions on the viscosity of the material can be drawn
and/or
   the magnetic field is height adjustable and thereby allows the stirring body to be put in a floating state
and/or
   the electronic control system is positioned at a distance from the system of coils.

In the present invention, individual, several, or all of the aforesaid features can be realized, creating a new type of magnetic stirrer.

Either stopping/stalling of the stirring body, or the viscosity of the material are detectable by means of phase shifts in the magnetic field, and/or by phase addition using several coils in the coil system, and/or by evaluating the alteration of the magnetic field of one coil in the magnetic circuit with variable magnetic resistance.

Conclusions about the viscosity of the material can be drawn in particular by detecting the delay or the advance of the stirring body compared to the magnetic field.

Furthermore, it is made possible for the first time to adjust the performance of the magnetic stirring system according to the viscosity of the material.

In addition, the vessel and the coil system are height-adjustable in relation to each other. Therefore, the stirrer bar does not rotate at the bottom of the vessel, but it is floating above it. The coil system is composed of a stator and at least three coils or coil pairs.

The preferred technical solution is a coil system with six coil pairs, whereby the coil pairs are separated and relatively offset by an angle of 60°, as well as being installed circularly around a longitudinal axis of the vessel. The coils can be controlled via pulse frequency modulated voltages, and are alternately magnetizable and demagnetizable by alteration of the pulse duration and sequence.

Impulses with differing durations can be implemented, allowing to adjust the ratio between pause and impulse time, as well as the cycle duration, while maintaining a constant amplitude.

Preferably, the pulse duration is shorter than the time to maximum coil magnetization. The construction and implementation of the stator within the vessel should ensure almost continuous and interruption-free magnetic fields. For this reason the stator has pole shoes which are fitted to the shape of the vessel wall. The edges of the pole shoes are therefore rounded off or beveled.

In the present invention, the magnetic flux of the stirring body can be increased in case of increasing viscosity of the material. This is implemented by the magnetic field becoming stronger with increasing speed. For this purpose, several single coils are combined to a multi coil (the preferred combination being two single coils combined to a double coil). The single coils in particular are made of wires of various diameters, and are either fitted on top of each other or in a row on one stator pole. If desired, several or all single coils of one multi coil can be connected. Therefore, the performance of the magnetic stirring system is variable. Connecting single coils can raise the performance in case of increasing viscosity, while in the event of decreasing viscosity, single coils can be switched off which reduces stirring power. Preferably, the stirring body should be a permanent-magnet.

The magnetic stirring system can be used to stir liquids, liquid/solid mixtures, liquid/gas mixtures, solid/gas mixtures or liquid/gas/solid mixtures with its stirring body. Because the power adjustment is viscosity-dependent, the stirring process is made effective, and can be terminated once a pre-determined level of viscosity is detected.

The invention will now be described by way of example with reference to the accompanying drawings.

The following figures are provided:

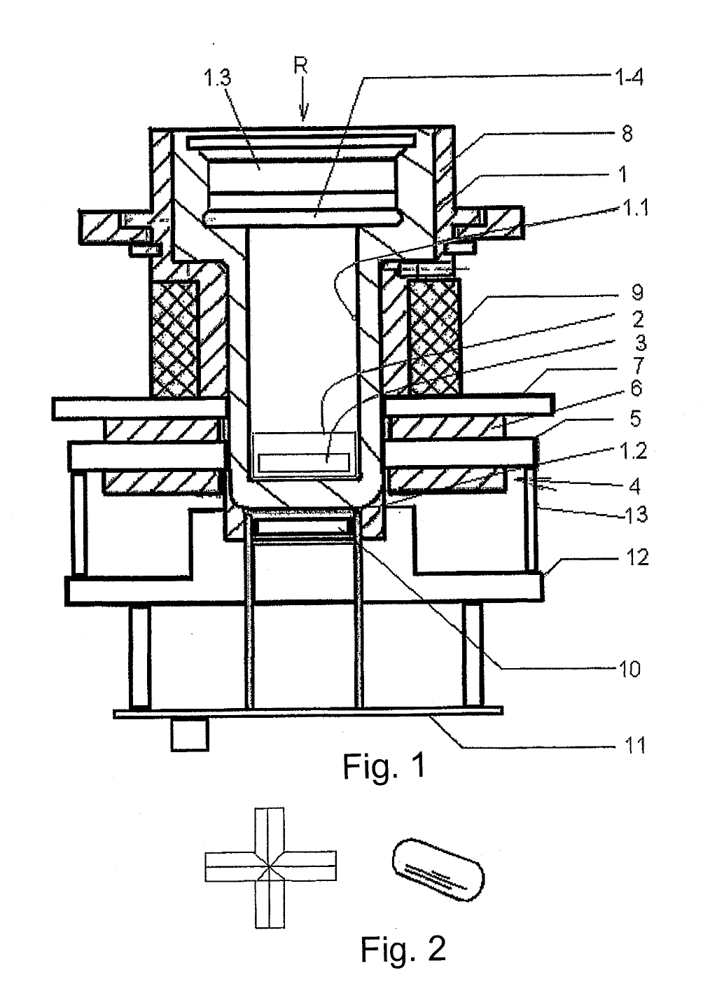

FIG. 1 shows the reactor module

FIG. 2 shows several design options for stirring bodies

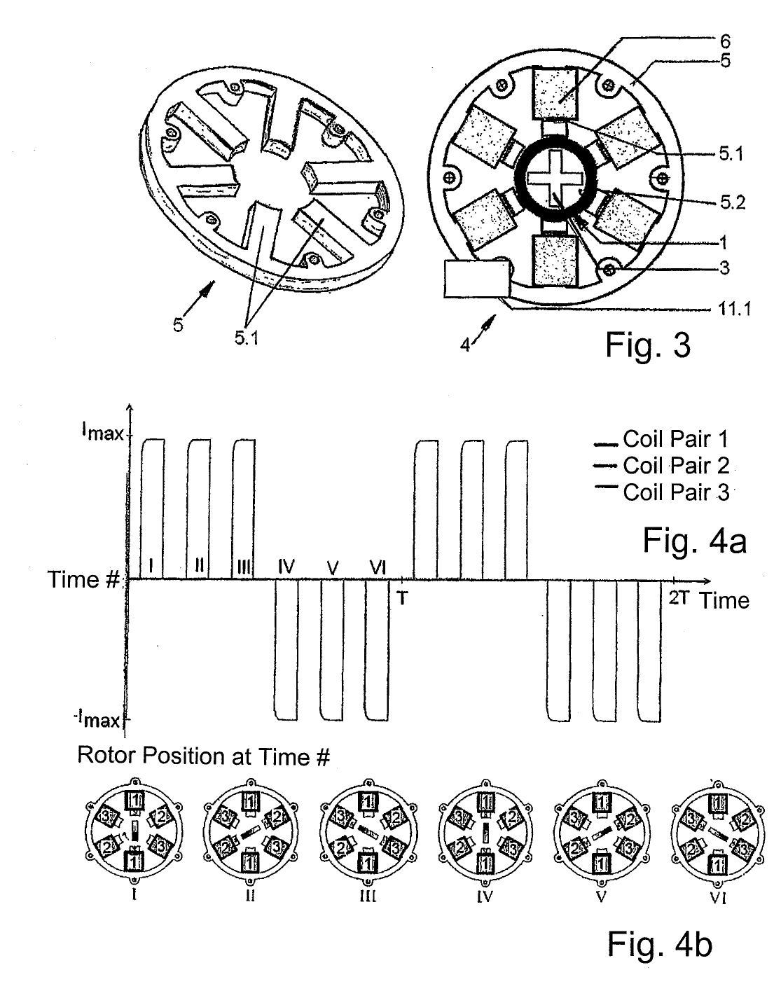

FIG. 3 shows the basic motor structure with six coils

FIG. 4 shows the diagram of the connected coils

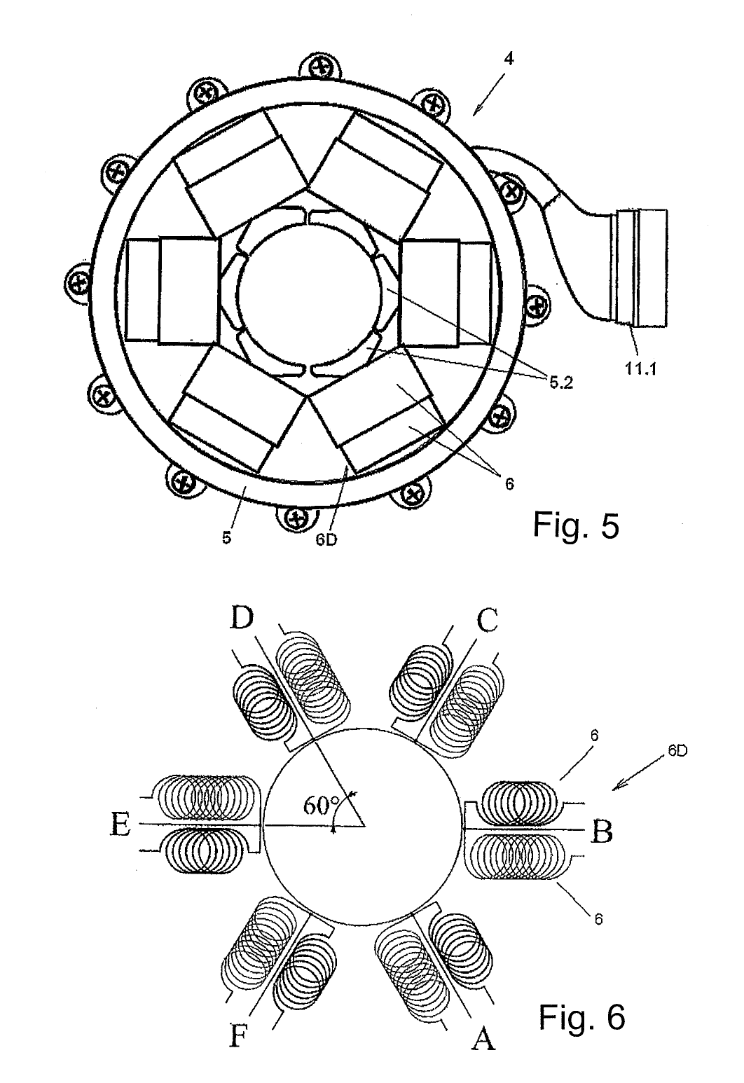

FIG. 5 shows coil pairs

FIG. 6 shows the coil configuration

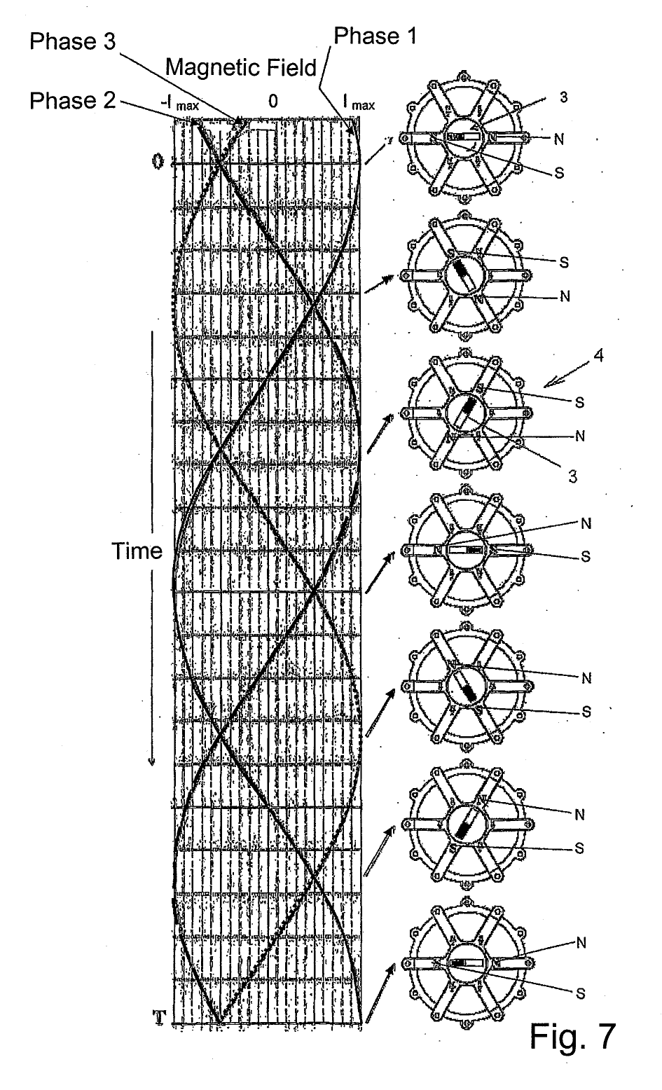

FIG. 7 shows the interaction of rotating field and radial flow impeller

As noted in FIG. 1, there is a longitudinal section of a reactor module R comprising a vessel 1 (preferably stainless steel) with a bottom 1.1 and a wall 1.2, which contains a material 2, into which a stirring body 3 is embedded. The vessel is lidded via a cover 1.3, whereat a gasket 1.4 is placed between the wall 1.2 and the cover 1.3 for reasons of sealing. Around the bottom 1.1 and the adjacent lower wall is winding a coil system 4 comprising a stator 5 and several coils 6. Above the coil system 4, an isolation 7 is arranged. A sleeve, preferably made of aluminium or another heat conductor, coats the wall 1.2 and the cover 1.3. Furthermore, the sleeve 8 is equipped with the stator 5. Adjacent to the wall 1.2, a heating unit 9 is intended to be attached to the sleeve 8 in order to reach the desired temperature level in the vessel 1. Below the bottom 1.1 a detector coil 10 is arranged.

Attached to the lower section of sleeve 8 are the detector coil 10 and the printed circuit board 11, which is assigned to the electronic control system. The coil system 4 is arranged on an adapter 12 through height-adjustable spacer bolts 13, thereby enabling coil system 4 to be adjusted in height to the bottom 1.1 of the reactor R. This can be implemented using an embodiment not depicted in this figure with an electric, hydraulic or pneumatic lifting unit. By a constructive setup simultaneous or selective heating and stirring of the material 2 in reactor R is achieved. The height adjustment of the coil system towards the reactor bottom allows the stirring body 3 to float above the bottom of the vessel within the material 2 in vessel 1.

As a stirring body 3 (rotor), commercial radial flow impellers of the chemical as well as the pharmaceutical industry may be used. In the simplest case of application, a magnetic stirrer 3 comprises a bar magnet moulded into a plastic housing. This plastic housing is made of PTFE (Teflon®), because this material is chemically inert. It can have different shapes and sizes, as noted in FIG. 2. According to FIG. 1, the stirring motor comprises three main components: the control electronics, the stator 5 with the coils 6, and the stirring body 3 serving as a rotor. The stator 5 is designed for an easy integration of the coils 6 during assembly. As noted in FIG. 3 the stator 5, which comprises six poles, is made of several layers. The individual layers comprise individual metal sheets (not depicted), and are combined to a stack of sheets. For example, the stack shown here comprises twelve individual layers. The coils 6 are then plugged onto the poles 5.1 of the stator 5 from within, and are fixed with heat resistant silicon. Afterwards, the poles 5.1 are equipped with pole pieces 5.2, which are fitted to the shape of the wall 1.2 of the vessel 1. The connection of the coils 6 is achieved by a connector board 11.1 attached to the printed circuit board 11 (not depicted), which is affixed to the stator 5 (FIG. 1). The whole stator 5 is then plugged onto the lower end of the sleeve 8, and attached to adapter 12 with the spacing bolts 13 thereby preventing the coil system 4 from slipping off.

The preferred solution consists of three coil pairs (pole pairs) comprising six individual coils each. All in all, the stirring motor thus consists of six coils.

The coils facing each other are interconnected in order to have the same magnetic alignment when connected to voltage. The use of several coils reduces the step range and allows a more precise adjustment of the stirring body 3 (rotor).

Thus, this stirring motor is a synchronous motor with an increased angular resolution through additional pole pairs.

As noted in FIG. 4, the single coils of the coil pairs are controlled such that only one of the coil pairs each is connected to voltage with the same polarity. The stirring bar, preferably permanent-magnetic, aligns its poles in order to achieve the maximum magnetic flux. This is the case when the poles of the wired coils and the complementary poles of the permanent magnet/stirring bar are facing each other.

After the alignment, the coils which have just been used are switched off, and the adjacent coil pair is switched on. Again, the rotor aligns itself to the magnetic field. This procedure allows creating a rotational motion in both directions.

FIG. 4 depicts the respective timing diagram (a) and the rotor positions (b).

The working voltage of the lifting unit is preferably 24 VDC. In order to provide power supply for the coils, a step-down converter is available, which receives the setpoint setting from the micro controller. This setpoint is manually set when the magnetic stirring system is commissioned, but it may be altered at all times if desired. The output voltage of the switching regulator serves as the power supply for the field coils inside the motor. The output voltage range can be 10 VDC to 15 VDC.

The virtual ground potential for the detection circuit is generated by a voltage divider containing resistors. The voltage of 5 VDC herein provided by the DCIDC converter is serving as reference voltage for the resistor array. By using the multiphase motor as the agitator drive and the unipolar armature, which is using both the impellers and the reactor fluids inertia, the coils have to be controlled in a pulsating manner. This is accomplished by a microcontroller generating the pulse frequency.

Thus, three circuits are necessary for controlling the whole coil system. The voltage provided by the step-down-converter can therefore be transmitted to the coils in “pulsed” form. Using these circuits minimizes the heat loss in the power module of the motor control circuit.

In order to calculate the rotary motion of the radial flow impeller, the detector coil 10 was arranged below the reactor (FIG. 1). The magnet inside the stirring body induces a sinusoidal signal into the detector coil 10, where the amplitude and frequency of this signal depends on the speed of the stirring body. The extracted sinusoidal signal is then converted into DC voltage by a precision rectifier, preferably after it has been filtered. After being converted into a direct voltage signal, an A/D converter creates a digital signal which can then be analyzed. Another possible mode of driving can be implemented through the principle of magnetic coupling between a circulating magnetic field and a radial flow impeller. The impeller comprises at least one bar magnet. The magnetic field thereto preferably consists of three sinusoidal individual magnetic fields, which are placed relatively offset at an angle of 120°. Thus, a three-phase rotary field is created. The rotary field together with the rotor magnet allow to implement a synchronous motor drive. In the simplest case, the stator of the synchronous motor comprises three coils which are offset in relation to each other at angle of 120°, and the corresponding radial flow impeller (rotor) consisting of a permanent magnet. If the stator windings are supplied with a three-phase current, a rotary field is created inside the stator. The field's rotational speed depends on the amount of coils and on the frequency of the three-phase current. For an amount of three stator coils (p=1) and a frequency of 60 Hz for instance, the rotational speed is 3600 rpm.

Because the rotor consists of at least one magnet, it comprises one north pole and one south pole. If the magnetic field generated in the stator flows through the rotor magnet, the latter strives to adjust itself to a maximum magnetic flux. The torsional moment acting on the rotor reaches its maximum when the stator's magnetic field is orthogonal to the rotor's poles. The rotor follows the circulating field without slippage, which means it is synchronized with the magnetic field. The speed of these motors can only be altered by constructive changes or by inserting frequency inverters. Since synchronous motors do not self-initiate, this has to be done by other motors in order to reach the desired speed.

For reasons of minimizing heating losses in the coils and the driver circuits the coils are controlled via pulse frequency modulated voltages in the revised drive. As a result, the respective coil is alternately charged and discharged. Since the pulse duration is shorter than 5 T, the heat generated by the Ohmic resistance is minimized and the coil's temperature increases slightly. Additionally, it has to be taken into account that the voltage passing through the coil equals the magnetic field strength.

A pulse frequency involving the generation of impulses of differing durations is herein referred to as a pulse frequency modulated signal. Thereby not only the relation of impulse-time and off-time is altered, but also the cycle duration of the total momentum. The amplitude remains constant, which allows the alteration of the motor speed while operating without the radial flow impeller to be stopped. It is important to make sure that at a speed of 350 rpm the pulse duration is shorter than the loading time of the coils used in order to ensure that the coils do not reach the point of saturation, and thus convert less energy into heat. The preferred pulse frequency is to be set by the resulting current being a sinusoidal signal.

It also has to be taken into consideration that the voltage going through the coil equals the magnetic field strength. If the field lines alter in their impulse time in a closed path, the cycle duration of the impulse is also altered. The amplitude remains constant, which allows the alteration of the motor speed while operating without the radial flow impeller to be stopped. It is important to make sure that the pulse duration is shorter than the loading time of the coils used in order to ensure that the coils do not reach the point of saturation, and thus do convert less energy into heat. The preferred pulse frequency is to be set by the resulting current being a sinusoidal signal.

The magnetic field strength has to rise when the speed is increased, which means that higher current flows are required at an increased speed. This can be done using an additional embodiment by combining several individual coils to a double coil, and manufacturing them with different sized wire. As noted in FIG. 5, the magnetic stirrer is preferably equipped with six double coils 6D, which are made of two individual coils 6 each. On the shared pole of the stator are sitting 5.1, 5 two single coils 6 each. The poles 5.1 comprise pole pieces 5.2, which are shaped similarly to the vessel wall (not depicted). The two single coils 6 combined to a double coil 6D comprise windings of different wire diameters. The double coils 4D are arranged relatively offset at an angle of 60°. Thus, the angle resolution of 120° is increased to 60°. In accordance with FIG. 1, the double coils 6D are arranged circularly around the vessel 1.

The stator 5 ensures that the magnetic fields inside reactor R are interruption-free, meaning that the magnetic poles only approach each other within certain limits. It is important to make sure that no sections exist within the reactor in which the radial flow impeller may stop. For this reason, the stator 5 was equipped with the pole shoes 5.2. The field lines are passing through the inner area of the reactor, and therefore create a connection between the stirring magnet and the surrounding magnetic field, thus minimizing the possibility of creating stray fields. Because the magnetic field lines are always perpendicular to the exit surface, the pole pieces are shaped like the outside wall of the sleeve. This ensures a maximal perfusion of the reactor. Preferably, the pole piece limits are rounded off with a small radius, e.g. 1 to 3 mm. Choosing a radius as small as possible ensures the maximal assumed number of the magnetic field lines to be smaller than it would be with a straight surface or a curve with a larger radius.

According to FIG. 5 the coil system comprises twelve coils, whereby two coils each are placed on a shared stator pole resulting in six double coils for the whole motor.

Preferably, the configuration of the coils is assembled as follows.

For a rotation rate being below 10000 rpm coils with e.g. 250 windings and enamelled copper wire with a diameter of 0.3 mm are connected in series for providing sufficient inductance for lower speeds. A lower inductance for higher speeds can be achieved by a switchover. In order to create a three-phase current three separate impulse sequences 15 have to be generated. Those are phase-shifted at an angle of 120°, as in a generator created three-phase current. Connecting the individual coils 6 of the double coils 6D according to FIG. 6 so that A, C and E are establishing the first pole pair, and B, D and F establish the second one ensures the function of a synchronous motor. During the generation of a rotating field, the phases are started at different time stages. The stirring body (not depicted) is thus aligning itself to the first phase every time the stirring process starts, which is of significance with regard to the detection principle used. When the adjusting is finished, the second and third phases are interconnected one after the other. By means of phase-shifting, accounting 120° for the second phase, and 240° for the third phase, the coils adjacent to the first phase generate complementary poles. Due to the fact that two equally charged poles push each other off, and two differently charged poles pull on to each other, a field is created which tightly surrounds the radial flow impeller. It comprises two supporting fields and a holding field for each pole pair. The fields located on the side of the stirring magnet are referred to as supporting fields which push off the stirring body because they have the same polarity. Being surrounded by a supporting field coming from the right, and another one coming from the left side the stirring body is held tightly. The field strength of the supporting fields is half as strong as the field strength of the holding field. The fields standing opposite to the stirring magnet pole are referred to as holding fields. Their polarity is complementary to the one of the stirring magnet such that the stirring magnet is pulled towards them. The coils inside the stator are connected such that the coils facing each other are arranged in a magnetic series connection. Thereby, it is led by two holding and two supporting fields each on both sides.

FIG. 7 shows another embodiment, which comprises the double coils 6D and the generating rotary field. This illustrates how the stirring bar 3 is rotating with appropriate controlling and switching of the double coils 6. A feedback from the radial flow impeller may become apparent either through phase-shifting or the addition of the three phases. In the present invention, the used detection principle is based on the alteration of the discharge time of one coil in the magnetic circuit at a variable magnetic resistance. By selectively turning on the three single phases, it is achieved that the radial flow impeller and the amplitude of the first phase are running simultaneously in normal operation. This implies that the stirring magnet is pointing towards the poles of the first phase coils at the time of maximum current in the first phase. Thus the air gap between the stirring magnet and the coil system, the first phase coils respectively, is minimized. For this reason, the detection takes place at this point. Shortly before reaching the maximum current the first phase driver module is switched to high resistance. The duration of the driver module deactivation depends on the coil system used. The coils are discharging dependently on the type of the coil system in a certain amount of time. If the radial flow impeller and the first phase are not running simultaneously anymore, the air gap is not minimal at the time of measurement, and the discharge time of the coils is changing. This does not only allow a detection where a distinction can be made between a rotating or a resting radial flow impeller, but it also allows a value detection of the delay or advance of the radial flow impeller in contrast to the field. Important for the detection are the starting impulse generated when the power stage is switched off and the stopping impulse generated after the process of discharging. Consequently, the gained detection signal allows not only a detection of the radial flow impeller movement, but also detection of delay.

For creating the impulse signal for generating the magnetic fields a microcontroller can be used which offers functions such as:
Time measurement start and stop
Detection reading analysis
Adaptation of the amplifier value to the present speed and the driver coils used for extracting the detection signal
Function monitoring of the impulse-generating controller
Clock signal generation for the modulation controller
Communication between system computer and the stirrer assembly
Controlling of the voltage converter to establish supply for the necessary coil system

Successfully tested stirring bars/rotor types are:
Stirring bar with a permanent magnet
Star-shaped radial flow impeller with three permanent magnets
Cross-shaped radial flow impeller with a bar shaped permanent magnet
Cross-shaped radial flow impeller with two bar shaped permanent magnets facing each other at an angle of 90°

The best results were achieved with the cross-shaped radial flow impeller. Two microcontrollers served as controlling units, whereby one of them is merely used for generating the rotary field. In order to achieve a high degree of efficiency the coils are controlled via pulse frequency modulated signals which ensure a precise generation of the rotary field with a wide frequency range, and thus different speeds of the radial flow impeller. In addition, the reactor is not heated by the coils, because they only warm up slightly, and therefore allows performing a reaction at room temperature level.

In order to achieve a high degree of efficiency for all speeds, a coil system with six poles generated by twelve coils was designed.

The detection of the rotary movement is implemented by a detector coil with the alteration of the magnetic resistance caused by the rotation of the stirring bar. The detection signal gained through this procedure not only allows a detection of the stirring bar rotation, but it also determines the delay.

1-26. (canceled)

27. A magnetic stirring system comprising a permanent-magnetic stirring body disposed in a vessel containing a stirrable material, and an electronic control unit; wherein:
the stirring body is rotatable in response to an applied rotating magnetic field which applies stirring power to the stirring body;
alterations of the rotational motion of the stirring body relative to the magnetic field are detectable;
the viscosity of the material can be estimated by analysing the detected alterations in the rotational motion of the stirring body relative to the magnetic field; and
the stirring power is adjustable depending on the estimated viscosity of the material.

28. A magnetic stirring system as claimed in claim 27, wherein the detectable alterations of the rotational motion of the stirring body relative to the magnetic field are selected from the group consisting of delay in the rotation of the stirring body relative to the magnetic field, advance in the rotation of the stirring body relative to the magnetic field; stalling of the rotation of the stirring body, and stopping of the rotation of the stirring body.

29. A magnetic stirring system as claimed in claim 27, wherein the rotating magnetic field is applied by a coil system, and alternations of the rotational motion of the stirring body are detected and the viscosity of the material is estimated by analyzing alternations in the magnetic field at least one coil of said coil system depending on signal quality.

30. A magnetic stirring system as claimed in claim 27, wherein the rotating magnetic field is applied by a magnetic circuit, and alterations of the rotational motion of the stirring body are detected and the viscosity of the material is estimated by analyzing variations in magnetic resistance of said magnetic circuit.

31. A magnetic stirring system as claimed in claim 27, wherein the magnetic field is adjustable in height so that the stirring body can be placed into a floating state.

32. A magnetic stirring system as claimed in claim 27, wherein the rotating magnetic field is applied by a coil system, said system further comprising a lifting unit for adjusting the height of the vessel or the coil system or both.

33. A magnetic stirring system as claimed in claim 27, wherein the rotating magnetic field is applied by a coil system comprising a stator and at least three coils or at least three pairs of coils.

34. A magnetic stirring system as claimed in claim 33, wherein said coil system comprises six coil pairs arranged circularly around a longitudinal axis of the vessel offset at an angle of 60° relative to adjacent coil pairs.

35. A magnetic stirring system as claimed in claim 33, wherein the coils are controlled via pulse frequency modulated currents and are alternately magnetizable and demagnetizable by alternating the pulse duration and sequence, and wherein the pulse duration is shorter than the time to maximum magnetization of the coils.

36. A magnetic stirring system as claimed in claim 35, wherein impulses of differing durations are generable, and by the ratio of pause and impulse time and the cycle duration of the impulse are variable while maintaining constant amplitude.

37. A magnetic stirring system as claimed in claim 33, wherein stator is constructed to provide substantially continuous, interruption-free magnetic fields within the vessel.

38. A magnetic stirring system as claimed in claim 37, wherein the stator comprises pole shoes which are fitted to the shape of the vessel wall, and the edges of the pole shoes are rounded off or bevelled.

39. A magnetic stirring system as claimed in claim 27, wherein an increased magnetic flux through the stirring body is achieved when the viscosity of the material increases, by increasing the strength of the magnetic field at higher rotational velocities.

40. A magnetic stirring system as claimed in claim 33, wherein a plurality of individual coils are combined to form a multi-coil assembly wherein the individual coils of a multi-coil assembly are either arranged on top of each other or in a row on a shared stator pole.

41. A magnetic stirring system as claimed in claim 40, wherein said multi-coil assembly is a double coil assembly.

42. A magnetic stirring system as claimed in claim 40, wherein the respective individual coils of a multi-coil assembly are made of wires of different diameters, and wherein the coils of a multi-coil assembly can be activated individually or in combinations of two or more coils.

43. A magnetic stirring system as claimed in claim 27, wherein the stirrable material is selected from the group consisting of liquids, liquid/solid mixtures, liquid/gas mixtures, solid/gas mixtures and liquid/gas/solid mixtures.

44. A method of stirring a stirrable material, said method comprising:
disposing said stirrable material in a vessel with a permanent-magnetic stirring body;
subjecting the stirring body to a rotating magnetic field to apply a stirring power to said stirring body and rotate the stirring body;
detecting alterations of the rotational motion of the stirring body relative to the magnetic field; and
adjusting the stirring power applied to the stirring body in response to detected alterations of the rotational motion of the stirring body to achieve a desired degree of stirring of the stirrable material.

45. A method as claimed in claim 44, wherein the viscosity of the material is estimated by analyzing the detected alterations in the rotational motion of the stirring body relative to the magnetic field; and the applied stirring power is adjusted depending on the estimated viscosity of the material.

46. A method as claimed in claim 44, wherein:
the rotating magnetic field is applied by a coil system;
the coils are controlled via pulse frequency modulated currents and are alternately magnetizable and demagnetizable by alternating the pulse duration and sequence;
the pulse duration is shorter than the time to maximum magnetization of the coils; and
impulses of differing durations are generable, and the ratio of pause and impulse time and the cycle duration of the impulse are variable while maintaining constant amplitude.
